(19) United States
(12) Patent Application Publication
(10) Pub. No.: US 2024/0233010 A1
(43) Pub. Date: Jul. 11, 2024

(54) SYSTEMS AND METHODS FOR CONSOLIDATING ACCOUNTS

(71) Applicant: Capital One Services, LLC, McLean, VA (US)

(72) Inventors: Anne Moshyedi, Washington, DC (US); Lindsay Ngo, Arlington, VA (US); Suchitra Jayaraman, Newark, DE (US); Kelly Chen, Arlington, VA (US)

(21) Appl. No.: 18/152,260

(22) Filed: Jan. 10, 2023

(51) Int. Cl. G06Q 40/03

(52) U.S. Cl. CPC G06Q 40/03

(57) ABSTRACT

Disclosed embodiments may include a system for consolidating accounts. The system may receive data corresponding to a user. The system may determine, via a first MLM and based on the data, a first account of a plurality of accounts to use as a primary account. The system may cause a user device to display, via a GUI, a first notification indicating the first account as the primary account. The system may normalize, via a second MLM, respective feature(s) of second account(s) of the plurality of accounts in comparison to the respective feature(s) of the first account. The system may cause the user device to display, via the GUI, a second notification indicating a consolidation of the second account(s) into the first account based on the normalized respective feature(s). The system may consolidate the second account(s) into the first account based on the second recommendation.

### FIELD

The disclosed technology relates to systems and methods for consolidating accounts. Specifically, this disclosed technology relates to determining an optimal account to be used as a primary account, and consolidating one or more secondary accounts into the primary account.

### BACKGROUND

Oftentimes, individuals may have multiple accounts, such as credit cards, with a single financial institution. Each of those multiple accounts may be associated with different features or benefits, such as a credit limit, transaction fees, interest rates, rewards, cash back, and the like. As such, individuals may choose to use a different card depending on the type of transaction being conducted in order to optimize any associated features or benefits.

Accordingly, there is a need for improved systems and methods for consolidating accounts. Embodiments of the present disclosure may be directed to this and other considerations.

### SUMMARY

Disclosed embodiments may include a system for consolidating accounts. The system may include one or more processors, and memory in communication with the one or more processors and storing instructions that, when executed by the one or more processors, are configured to cause the system to consolidate accounts. The system may receive data corresponding to a user, the data comprising a plurality of accounts. The system may retrieve travel information based on the data. The system may generate, via a first machine learning model (MLM) and based on the data and the travel information, a first recommendation for a first account of the plurality of accounts to use as a primary account. The system may cause a user device to display, via a graphical user interface (GUI), a first notification including the first recommendation, the user device associated with the user. The system may receive, from the user via the user device, a first response to the first notification. Responsive to receiving the first response, the system may normalize, via a second MLM, one or more respective features of one or more second accounts of the plurality of accounts in comparison to the one or more respective features of the first account. The system may cause the user device to display, via the GUI, a second notification including a second recommendation for consolidating the one or more second accounts into the first account based on the normalized one or more respective features. The system may receive, from the user via the user device, a second response to the second notification. Responsive to receiving the second response, the system may consolidate the one or more second accounts into the first account based on the second recommendation.

Disclosed embodiments may include a system for consolidating accounts. The system may include one or more processors, and memory in communication with the one or more processors and storing instructions that, when executed by the one or more processors, are configured to cause the system to consolidate accounts. The system may receive data corresponding to a user, the data comprising a plurality of accounts. The system may determine, via a first machine learning model (MLM) and based on the data, a first account of the plurality of accounts to use as a primary account. The system may cause a user device to display, via a graphical user interface (GUI), a first notification indicating the first account as the primary account, the user device associated with the user. The system may normalize, via a second MLM, one or more respective features of one or more second accounts of the plurality of accounts in comparison to the one or more respective features of the first account. The system may cause the user device to display, via the GUI, a second notification indicating a consolidation of the one or more second accounts into the first account based on the normalized one or more respective features. The system may consolidate the one or more second accounts into the first account.

Disclosed embodiments may include a system for consolidating accounts. The system may include one or more processors, and memory in communication with the one or more processors and storing instructions that, when executed by the one or more processors, are configured to cause the system to consolidate accounts. The system may receive data corresponding to a user, the data comprising a plurality of accounts. The system may cause a user device to display, via a graphical user interface (GUI), a listing of the plurality of accounts and one or more selectable user input objects proximate each of the plurality of accounts, wherein the user device is associated with the user. The system may receive, from the user via the user device, a first selection of the one or more selectable user input objects, the first selection indicating a first preference to assign a first account of the plurality of accounts as a primary account of the user. Responsive to receiving the first selection, the system may modify the GUI to generate a first modified GUI including an indication of the first account as the primary account, and cause the user device to display the first modified GUI. The system may receive, from the user via the user device, a second selection of the one or more selectable user input objects, the second selection indicating a second preference to consolidate a second account of the plurality of accounts with the first account. Responsive to receiving the second selection, the system may consolidate the second account into the first account, and retrieve one or more respective features of the first and second accounts. The system may receive a request to complete a transaction using the first account. The system may determine whether the transaction exceeds a predetermined threshold. Responsive to determining the transaction does not exceed the predetermined threshold, the system may authorize the transaction based on the one or more respective features of the first account. Responsive to determining the transaction exceeds the predetermined threshold, the system may authorize the transaction based on the one or more respective features of the second account.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for consolidating accounts in accordance with certain embodiments of the disclosed technology.

FIGS. 2A-2B are a flow diagram illustrating an exemplary method for consolidating accounts in accordance with certain embodiments of the disclosed technology.

FIG. 3 is block diagram of an example account determination system used to consolidate accounts, according to an example implementation of the disclosed technology.

FIG. 4 is block diagram of an example system that may be used to consolidate accounts, according to an example implementation of the disclosed technology.

### DETAILED DESCRIPTION

When individuals have multiple accounts, such as credit card accounts, there may be situations where those individuals prefer not to carry around a card or account information associated with each of those multiple accounts, such as when those individuals may be traveling away from home. Those individuals may opt to select a single card, or information associated with only a single account (e.g., an account number, mobile application virtual card, etc.), to reduce the chances of having multiple cards or types of account information be compromised (e.g., stolen, lost, etc.). Selecting a single card or account, however, may be challenging considering the different features or benefits associated with each account, and how those features or benefits may apply to transactions conducted, such as those conducted in different geographic locations.

Accordingly, examples of the present disclosure may provide for determining a first account of a plurality of accounts to use as a primary account, normalizing respective features of one or more second accounts in comparison to the respective features of the first account, and consolidating the second account(s) into the first account based on the normalized respective features.

Disclosed embodiments may employ machine learning models (MLMs), among other computerized techniques, to determine a first account of a plurality of accounts to use as a primary account, and to normalize respective features of second account(s) in comparison to respective features of the first account such that the second account(s) can be consolidated into the first account. Machine learning models are a unique computer technology that involves training models to complete tasks and make decisions. These techniques may help to improve database and network operations. For example, the systems and methods described herein may utilize, in some instances, MLMs, which are necessarily rooted in computers and technology, to evaluate data corresponding to a user to determine which of the user's accounts would be optimal for use as a primary account versus second account(s). This, in some examples, may involve using financial-, transaction-, credit-, and/or travel-related input data and an MLM, applied to determine an ideal account for use as a primary account and to normalize features of second account(s) with respect to those of the primary account. Using an MLM and a computer system configured in this way may allow the system to provide a customized primary account recommendation based on a variety of user-specific input data.

This may provide an advantage and improvement over prior technologies that may provide a one-to-one transfer of available credit between cards regardless of the cards' respective unique features and benefits. The present disclosure solves this problem by determining an optimal primary account based on normalizing respective features of various accounts. Furthermore, examples of the present disclosure may also improve the speed with which computers can determine optimal primary accounts versus secondary accounts. Overall, the systems and methods disclosed have significant practical applications in the account consolidation field because of the noteworthy improvements of the normalization of account features and determination of optimal primary accounts, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

In some embodiments of the disclosed technology, the term “consolidate” may mean transferring the respective features (e.g., interest rate, credit line, fees, rewards, points, cashback percentage, benefits, etc.) of a first account (e.g., a credit card account) into a second account. For example, the credit line of a first account may be transferred to a second account such that the first account credit line is reduced to zero, while the resulting second account credit line is the sum of its own credit line and the original credit line of the first account.

In some embodiments of the disclosed technology, the term “consolidate” may mean keeping various accounts (e.g., credit card accounts) separate, but generating a process whereby individual transactions may be posted to a particular account of the various accounts based on, for example, customer preference and/or an MLM.

In some embodiments of the disclosed technology, the term “consolidate” may mean either transferring the respective features of a first account into a second account (as discussed above), or generating a process whereby individual transactions may be posted to a particular account (as discussed above), yet further based on received user or customer input.

Reference will now be made in detail to example embodiments of the disclosed technology that are illustrated in the accompanying drawings and disclosed herein. Wherever convenient, the same reference numbers will be used throughout the drawings to refer to the same or like parts.

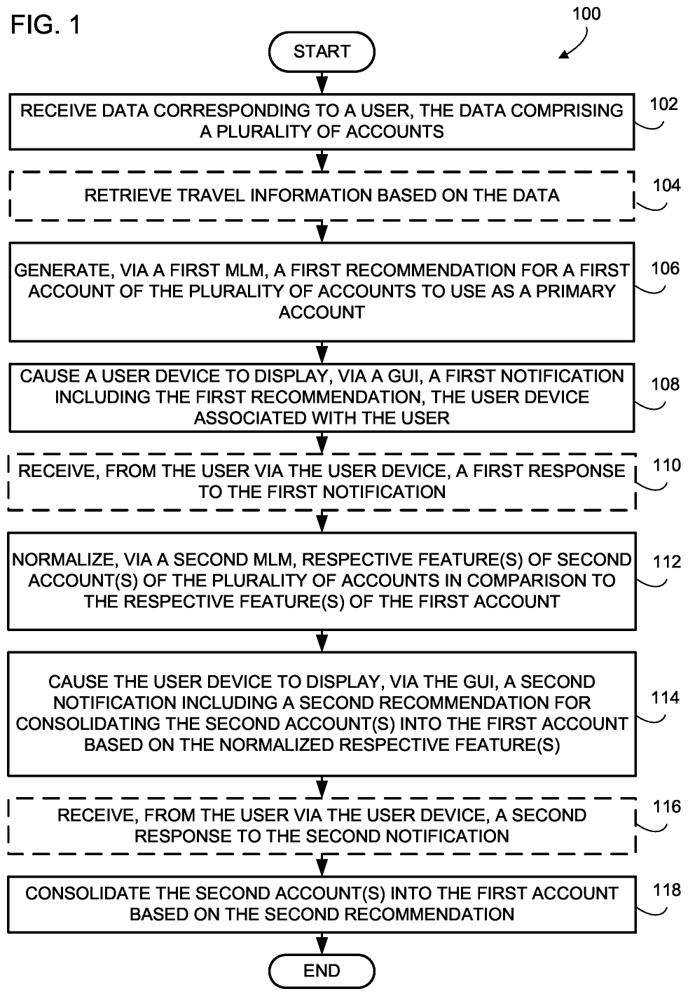

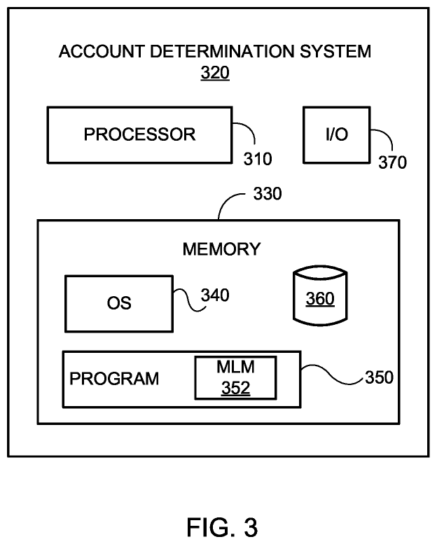

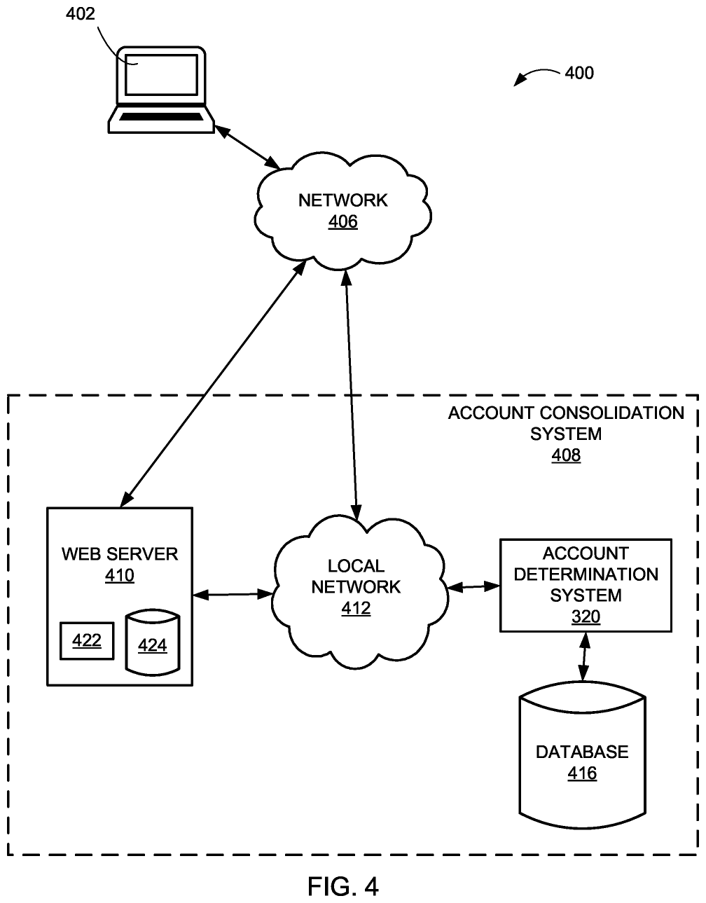

FIG. 1 is a flow diagram illustrating an exemplary method 100 for consolidating accounts, in accordance with certain embodiments of the disclosed technology. The steps of method 100 may be performed by one or more components of the system 400 (e.g., account determination system 320 or web server 410 of account consolidation system 408, or user device 402), as described in more detail with respect to FIGS. 3 and 4. While certain blocks may be identified as being optional, certain embodiments may omit blocks even if they are not necessarily identified as being optional.

In block 102, the account determination system 320 may receive data corresponding to a user, the data comprising a plurality of accounts. In some embodiments, the system may be owned and/or operated by an entity (e.g., a financial institution) that may have access to various types of data corresponding to a user (e.g., a customer), such as the user's various accounts (e.g., credit, debit, savings, checking, etc.), financial information, transaction information, credit information, travel destinations, dates, times, and the like. In some embodiments, the system may be configured to receive the data in real-time (e.g., as the user conducts a transaction, enters financial information into a user profile or accounts, etc.), and/or in batches. In some embodiments, the system may be provided access to the data via, for example, user preferences entered by the user into an associated account or profile.

In optional block 104, the account determination system 320 may retrieve travel information based on the data. In some embodiments, the travel information may include travel advisories, foreign transaction fees, etc. In some embodiments, the system may be configured to utilize the received data (block 102) in determining the user may likely be planning an upcoming trip, for example, based on evaluating incoming transaction data, including travel reservations made for an upcoming date and/or time. In some embodiments, upon determining the user may likely be planning upcoming travel, the system may retrieve travel information associated with the location or destination to which the user may be traveling. In some embodiments, the system may utilize a web crawler to retrieve the travel information from various sources.

In block 106, the account determination system 320 may generate, via a first MLM and based on the data, a first recommendation for a first account of the plurality of accounts to use as a primary account. In some embodiments, the first MLM may evaluate the received data (block 102) to determine which account of the user's multiple accounts may provide the user with the most benefit while traveling. For example, the first MLM may be configured to rank various respective rewards or features associated with each of the user's accounts, as further discussed herein, to prioritize which rewards or features may provide most value to the user while traveling. In some embodiments, the first MLM may further base the first recommendation on the retrieved travel data (block 104) such that the recommendation may be further optimized based on the specific location or destination to which the user may be traveling.

In block 108, the account determination system 320 may cause a user device to display, via a graphical user interface (GUI), a first notification including the first recommendation, the user device associated with the user. For example, the system may be configured to generate a push-notification, email, text message, etc., and provide such notification to the user to provide the user with the primary account recommendation. In some embodiments, the system may display such notification in a mobile application, such as a travel portal. In some embodiments, the system may display such notification including one or more selectable user input objects (e.g., radio buttons, textboxes, drop-down menus, toggle switches, slider buttons, etc.) such that the user may respond to the recommendation, as further discussed below.

In optional block 110, the account determination system 320 may receive, from the user via the user device, a first response to the first notification. For example, the user may select one of the selectable user input objects within the notification, as discussed above, to accept or deny the system's first recommendation.

In block 112, responsive to receiving the first response, the account determination system 320 may normalize, via a second MLM, one or more respective features of one or more second accounts of the plurality of accounts in comparison to the one or more respective features of the first account. In some embodiments, the respective features may include interest rate, credit line, fees, rewards, points, cashback percentage, benefits, and the like. In some embodiments, the second MLM (e.g., a neural network) may be configured to normalize these features with respect to one another, for example, by determining a normalized priority or ranking of the features (e.g., in units of dollars earned per dollar spent).

In block 114, the account determination system 320 may cause the user device to display, via the GUI, a second notification including a second recommendation for consolidating the one or more second accounts into the first account based on the normalized one or more respective features. In some embodiments, the second notification may be displayed to the user in a same or similar fashion as the first notification, as discussed above. For example, the user may receive a notification including a display, e.g., a listing with toggle switches displayed next to each account name or identifier, of one or more accounts other than the first/primary account, that the user may wish to consolidate into the first/primary account.

In optional block 116, the account determination system 320 may receive, from the user via the user device, a second response to the second notification. In some embodiments, the system may receive the second response in a same or similar fashion as it received the first response, as discussed above. In some embodiments, the user may select one or more secondary accounts to consolidate into the first/primary account by, e.g., manipulating one or more toggle switches, as discussed above, displayed proximate each of the user's various accounts.

In block 118, responsive to receiving the second response, the account determination system 320 may consolidate the one or more second accounts into the first account based on the second recommendation. In some embodiments, the system may consolidate the second account(s) into the first account by transferring some or all available credit from the second account(s) to the first account.

In some embodiments, a user can make the first account active or inactive, for example, by manipulating toggle switches within a GUI of the user's mobile device. For example, the user can specify whether he/she would like to “lock” the entire consolidated credit line (e.g., in the case of fraud or theft), and/or to “cancel” the consolidation of the second accounts with the first account, thereby reallocating the respective credit lines back to the first account and second account(s).

In some embodiments, a user can select a predetermined amount of time during which an account consolidation should take place. For example, the user can specify that he/she would like the second account(s) to be consolidated into a first, primary account over a certain period of time (e.g., hours, days, weeks, etc.). For example, the user may make selections within an interactive GUI of the user's mobile device where the selections indicate a date and/or time when the second account(s) should be consolidated into the first, primary account, and/or a date and/or time when the consolidation of the accounts should end to thereby reallocate the respective credit lines back to the first and second account(s).

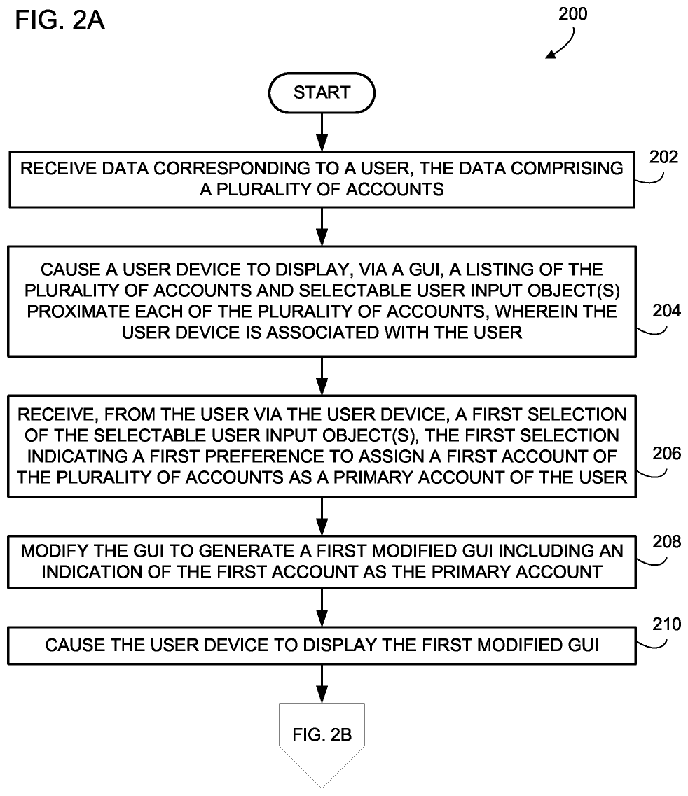

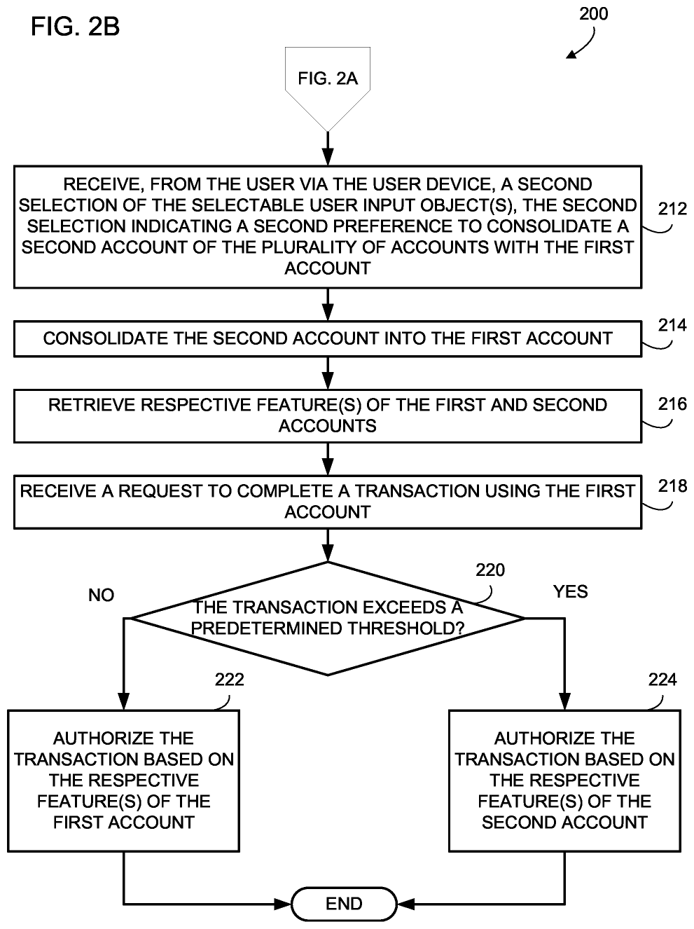

FIGS. 2A-2B are a flow diagram illustrating an exemplary method 200 for consolidating accounts, in accordance with certain embodiments of the disclosed technology. The steps of method 200 may be performed by one or more components of the system 400 (e.g., account determination system 320 or web server 410 of account consolidation system 408, or user device 402), as described in more detail with respect to FIGS. 3 and 4.

Method 200 of FIGS. 2A-2B may be the same as or similar to method 100 of FIG. 1. except that method 200 may provide a method by which a system receives user input with respect to primary and/or secondary account(s) via a GUI. The respective descriptions of blocks 202 and 214 of method 200 may be the same as or similar to the respective descriptions of blocks 102 and 118 of method 100, and as such, are not repeated herein for brevity.

In block 204, the account determination system 320 may cause a user device to display, via a GUI, a listing of the plurality of accounts and one or more selectable user input objects proximate each of the plurality of accounts, wherein the user device is associated with the user. In some embodiments, the system may display such listing in a mobile application, such as a travel portal. In some embodiments, the one or more selectable user input objects (e.g., buttons, textboxes, drop-down menus, toggle switches, etc.) may be displayed such that the user may select which account to label as the primary account and which as the secondary account(s), as further discussed below.

In block 206, the account determination system 320 may receive, from the user via the user device, a first selection of the one or more selectable user input objects, the first selection indicating a first preference to assign a first account of the plurality of accounts as a primary account of the user. For example, the user may manipulate a toggle switch displayed proximate a certain account such that the toggle switch changes from an “off” position to an “on” position, or a “secondary” position to a “primary” position.

In block 208, responsive to receiving the first selection, the account determination system 320 may modify the GUI to generate a first modified GUI including an indication of the first account as the primary account. For example, the modified GUI may include the same listing of accounts; however, may display a label or icon proximate the selected account indicating that account has been deemed the primary account. In some embodiments, the modified GUI may display the selected account in a different format, such as a different color or font, when the user switches the toggle switch, as discussed above.

In block 210, the account determination system 320 may cause the user device to display the first modified GUI. For example, the system may display the first modified GUI via a mobile application such that the user may view the changes in account status (e.g., primary to secondary, or secondary to primary).

In block 212, the account determination system 320 may receive, from the user via the user device, a second selection of the one or more selectable user input objects, the second selection indicating a second preference to consolidate a second account of the plurality of accounts with the first account. This step may be the same as or similar to block 206, as discussed above.

In block 216, responsive to receiving the second selection, the account determination system 320 may retrieve one or more respective features of the first and second accounts. The respective feature(s) may be the same as or similar to those as discussed above with respect to method 100.

In block 218, the account determination system 320 may receive a request to complete a transaction using the first account. In some embodiments, the system may receive the request via, for example, an online merchant or physical point-of-sale (POS) device.

In block 220, the account determination system 320 may determine whether the transaction exceeds a predetermined threshold. In some embodiments, the predetermined threshold may be a default threshold selected by the system, or may be a threshold pre-selected by the user (e.g., via user preferences in a user profile or account). In some embodiments, the predetermined threshold may be a transaction amount (e.g., in dollars), a credit limit, etc.

In block 222, responsive to determining the transaction does not exceed the predetermined threshold (e.g., the transaction falls below a certain dollar amount, or results in the first account's overall credit not exceeding a certain total credit line), the account determination system 320 may authorize the transaction based on the one or more respective features of the first account. For example, the system may be configured to process and/or authorize the transaction according to the respective features of the first account (e.g., the rewards, transaction fees, interest rates, etc.).

In some embodiments, responsive to consolidating the one or more second accounts into the first account, as discussed above, the system may process and/or authorize the transaction based on the one or more respective features of the first account. For example, the system may not process and/or authorize the transaction according to respective features of the first and second account(s) based on a predetermined threshold, as discussed above. Instead, once the second account(s) are consolidated into the first account, the system may automatically process and/or authorize any first account transactions using the respective feature(s) of the first account.

In block 224, responsive to determining the transaction exceeds the predetermined threshold, the account determination system 320 may process and/or authorize the transaction based on the one or more respective features of the one or more second accounts.

In some embodiments, once a user has selected to consolidate a secondary account(s) into a first account, as discussed above, it may appear to the user that all of his/her transactions are being processed according to the respective feature(s) of the first account, for example, as the user tracks his/her transactions via a mobile application. However, in such embodiments, the system may be configured to apply the respective feature(s) of the first account only up to a predetermined threshold (e.g., a credit limit of the first account), and to apply the respective feature(s) of the second account(s) above such predetermined threshold.

FIG. 3 is a block diagram of an example account determination system 320 used to consolidate accounts, according to an example implementation of the disclosed technology. According to some embodiments, the user device 402 and web server 410, as depicted in FIG. 4 and described below, may have a similar structure and components that are similar to those described with respect to account determination system 320 shown in FIG. 3. As shown, the account determination system 320 may include a processor 310, an input/output (I/O) device 370, a memory 330 containing an operating system (OS) 340 and a program 350. In some embodiments, program 350 may include an MLM 352 that may be trained, for example, to determine an optimal primary account based on user data, and to normalize respective features of secondary account(s) based on respective features of the primary account. In certain implementations, MLM 352 may issue commands in response to processing an event, in accordance with a model that may be continuously or intermittently updated. Moreover, processor 310 may execute one or more programs (such as via a rules-based platform or the trained MLM 352), that, when executed, perform functions related to disclosed embodiments.

In certain example implementations, the account determination system 320 may be a single server or may be configured as a distributed computer system including multiple servers or computers that interoperate to perform one or more of the processes and functionalities associated with the disclosed embodiments. In some embodiments account determination system 320 may be one or more servers from a serverless or scaling server system. In some embodiments, the account determination system 320 may further include a peripheral interface, a transceiver, a mobile network interface in communication with the processor 310, a bus configured to facilitate communication between the various components of the trust score generation system 320, and a power source configured to power one or more components of the trust score generation system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), NFC, Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public. as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the account determination system 320 may include one or more storage devices configured to store information used by the processor 310 (or other components) to perform certain functions related to the disclosed embodiments. In one example, the account determination system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The account determination system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the account determination system 320 may include the memory 330 that may include one or more programs 350 to perform one or more functions of the disclosed embodiments. For example, in some embodiments, the account determination system 320 may additionally manage dialogue and/or other interactions with the customer via a program 350.

The processor 310 may execute one or more programs 350 located remotely from the trust score generation system 320. For example, the account determination system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a database 360 for storing related data to enable the account determination system 320 to perform one or more of the processes and functionalities associated with the disclosed embodiments.

The database 360 may include stored data relating to status data (e.g., average session duration data, location data, idle time between sessions, and/or average idle time between sessions) and historical status data. According to some embodiments, the functions provided by the database 360 may also be provided by a database that is external to the account determination system 320, such as the database 416 as shown in FIG. 4.

The account determination system 320 may also be communicatively connected to one or more memory devices (e.g., databases) locally or through a network. The remote memory devices may be configured to store information and may be accessed and/or managed by the account determination system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The account determination system 320 may also include one or more I/O devices 370 that may comprise one or more interfaces for receiving signals or input from devices and providing signals or output to one or more devices that allow data to be received and/or transmitted by the account determination system 320. For example, the account determination system 320 may include interface components, which may provide interfaces to one or more input devices, such as one or more keyboards, mouse devices, touch screens, track pads, trackballs, scroll wheels, digital cameras, microphones, sensors, and the like, that enable the account determination system 320 to receive data from a user (such as, for example, via the user device 402).

In examples of the disclosed technology, the account determination system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The account determination system 320 may contain programs that train, implement, store, receive, retrieve, and/or transmit one or more MLMs. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The account determination system 320 may be configured to adjust model parameters during training. Model parameters may include weights, coefficients, offsets, or the like. Training may be supervised or unsupervised.

The account determination system 320 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The account determination system 320 may be configured to optimize statistical models using known optimization techniques.

Furthermore, the account determination system 320 may include programs configured to retrieve, store, and/or analyze properties of data models and datasets. For example, account determination system 320 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The account determination system 320 may include algorithms to determine a data type, key-value pairs, row-column data structure, statistical distributions of information such as keys or values, or other property of a data schema may be configured to return a statistical profile of a dataset (e.g., using a data-profiling model). The account determination system 320 may be configured to implement univariate and multivariate statistical methods. The account determination system 320 may include a regression model, a Bayesian model, a statistical model, a linear discriminant analysis model, or other classification model configured to determine one or more descriptive metrics of a dataset. For example, account determination system 320 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The account determination system 320 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, account determination system 320 may be configured to generate a similarity metric representing a measure of similarity between data in a dataset. A similarity metric may be based on a correlation, covariance matrix, a variance, a frequency of overlapping values, or other measure of statistical similarity.

The account determination system 320 may be configured to generate a similarity metric based on data model output, including data model output representing a property of the data model. For example, account determination system 320 may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The account determination system 320 may be configured to classify a dataset. Classifying a dataset may include determining whether a dataset is related to another dataset. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The account determination system 320 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, account determination system 320 is configured to generate and/or train a classification model to classify a dataset, consistent with disclosed embodiments.

The account determination system 320 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via a weighted connections. Prediction models may additionally or alternatively include classification and regression trees, or other types of models known to those skilled in the art. To generate prediction models, the asset detection system may analyze information applying machine-learning methods.

While the account determination system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the account determination system 320 may include a greater or lesser number of components than those illustrated.

FIG. 4 is a block diagram of an example system that may be used to view and interact with account consolidation system 408, according to an example implementation of the disclosed technology. The components and arrangements shown in FIG. 4 are not intended to limit the disclosed embodiments as the components used to implement the disclosed processes and features may vary. As shown, account consolidation system 408 may interact with a user device 402 via a network 406. In certain example implementations, the account consolidation system 408 may include a local network 412, an account determination system 320, a web server 410, and a database 416.

In some embodiments, a respective user may operate the user device 402. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the account consolidation system 408. In some embodiments, the user device 402 may include or incorporate electronic communication devices for hearing or vision impaired users.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the account consolidation system 408. According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The account determination system 320 may include programs (scripts, functions, algorithms) to configure data for visualizations and provide visualizations of datasets and data models on the user device 402. This may include programs to generate graphs and display graphs. The account determination system 320 may include programs to generate histograms, scatter plots, time series, or the like on the user device 402. The account determination system 320 may also be configured to display properties of data models and data model training results including, for example, architecture, loss functions, cross entropy, activation function values, embedding layer structure and/or outputs, convolution results, node outputs, or the like on the user device 402.

The network 406 may be of any suitable type, including individual connections via the internet such as cellular or WiFi networks. In some embodiments, the network 406 may connect terminals, services, and mobile devices using direct connections such as RFID, NFC, Bluetooth™, BLE, WiFi™, ZigBee™, ABC protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The account consolidation system 408 may be associated with and optionally controlled by one or more entities such as a business, corporation, individual, partnership, or any other entity that provides one or more of goods, services, and consultations to individuals such as customers. In some embodiments, the account consolidation system 408 may be controlled by a third party on behalf of another business, corporation, individual, partnership. The account consolidation system 408 may include one or more servers and computer systems for performing one or more functions associated with products and/or services that the organization provides.

Web server 410 may include a computer system configured to generate and provide one or more websites accessible to customers, as well as any other individuals involved in accessing account consolidation system 408's normal operations. Web server 410 may include a computer system configured to receive communications from user device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a financial service provider website that a user device may access by providing an attempted login that are authenticated by the account determination system 320. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™.

The local network 412 may include any type of computer networking arrangement used to exchange data in a localized area, such as WiFi, Bluetooth™, Ethernet, and other suitable network connections that enable components of the account consolidation system 408 to interact with one another and to connect to the network 406 for interacting with components in the system 400 environment. In some embodiments, the local network 412 may include an interface for communicating with or linking to the network 406. In other embodiments, certain components of the account consolidation system 408 may communicate via the network 406, without a separate local network 406.

The account consolidation system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access account consolidation system 408 using the cloud computing environment. User device 402 may be able to access account consolidation system 408 using specialized software. The cloud computing environment may eliminate the need to install specialized software on user device 402.

In accordance with certain example implementations of the disclosed technology, the account consolidation system 408 may include one or more computer systems configured to compile data from a plurality of sources, such as the account determination system 320, web server 410, and/or the database 416. The account determination system 320 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include transaction data, financial data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

### Example Use Case

The following example use case describes examples of a typical user flow pattern. This section is intended solely for explanatory purposes and not in limitation.

In one example, a customer may have two credit cards with a financial institution. The first and second credit cards may have $5,000 and $2,000 credit limits, respectively. The customer may be traveling internationally between Nov. 10, 2022 and Nov. 20, 2022. For this time period, the customer may decide to temporarily reduce the credit limit on the second credit card from $2,000 to $1,000, and reallocate that $1,000 credit line to the first credit card. In this case, the customer can now use a $6,000 limit on the first credit card and leave the second credit card at home while the user is traveling.

In some embodiments, to the user, it may appear (e.g., by tracking the user's transactions via a mobile application) that the user is spending $6,000 on the first credit card. The system may be configured, however, to ensure that any terms and benefits of the first credit card are applied on any transactions up to the original $5,000 spent, while any terms and benefits of the second credit card are applied on any transactions above $5,000 and up to $6,000.

In another example, a customer may have two credit cards with a financial institution. The first and second credit cards may have $5,000 and $2,000 credit limits, respectively. A system owned and/or operated by the financial institution, tracking the customer's transaction information, may determine or predict that the customer will be traveling internationally between Nov. 10, 2022 and Nov. 20, 2022. The system may utilize an MLM (e.g., a neural network) configured to determine which credit card (the first or second) would be optimal for use as the user's primary credit card while the user is traveling. The system may make this determination by evaluating the terms and benefits associated with the first and second credit cards, and determining which may have more value to the user during the user's travels. The system may provide the user with a recommendation to use the first credit card as the user's primary credit card (e.g., by transmitting a push notification to the user's mobile device). The system may wait for a response from the user, or may automatically (without user input) assign the first credit card as the primary account. The system may then normalize the terms and benefits associated with the second credit card in comparison to those associated with the first credit card, such that the second credit card may be consolidated into the first credit card. When the user then conducts transactions using the first credit card, the terms and conditions associated with the first credit card may be applied to all transactions up to the total combined $7,000 credit limit.

In some embodiments, the customer can make the first credit card (or the temporary travel card) active or inactive, for example, by manipulating toggle switches within a GUI of the user's mobile device. The customer can specify whether he/she would like to “lock” the entire combined $7,000 credit line (e.g., in the case of fraud or theft), or to “cancel” the temporary travel card, thereby reallocating the respective credit lines back to the first and second credit cards.

In some examples, disclosed systems or methods may involve one or more of the following clauses:

Clause 1: A system comprising: one or more processors; and a memory in communication with the one or more processors and storing instructions that, when executed by the one or more processors, are configured to cause the system to: receive data corresponding to a user, the data comprising a plurality of accounts; retrieve travel information based on the data; generate, via a first machine learning model (MLM) and based on the data and the travel information, a first recommendation for a first account of the plurality of accounts to use as a primary account; cause a user device to display, via a graphical user interface (GUI), a first notification including the first recommendation, the user device associated with the user; receive, from the user via the user device, a first response to the first notification; responsive to receiving the first response, normalize, via a second MLM, one or more respective features of one or more second accounts of the plurality of accounts in comparison to the one or more respective features of the first account; cause the user device to display, via the GUI, a second notification including a second recommendation for consolidating the one or more second accounts into the first account based on the normalized one or more respective features; receive, from the user via the user device, a second response to the second notification; and responsive to receiving the second response, consolidate the one or more second accounts into the first account based on the second recommendation.

Clause 2: The system of clause 1, wherein the data comprises one or more of financial information, transaction information, credit information, a travel destination, a date, a time, or combinations thereof.

Clause 3: The system of clause 1, wherein the travel information comprises one or more of travel advisories, foreign transaction fees, or both.

Clause 4: The system of clause 1, wherein the second MLM comprises a neural network.

Clause 5: The system of clause 1, wherein the one or more respective features comprise one or more of interest rate, credit line, fees, rewards, points, cashback percentage, benefits, or combinations thereof.

Clause 6: The system of clause 1, wherein the instructions are further configured to cause the system to: receive a request to complete a transaction using the first account; responsive to consolidating the one or more second accounts into the first account, determine whether the transaction exceeds a predetermined threshold; responsive to determining the transaction does not exceed the predetermined threshold, authorize the transaction based on the one or more respective features of the first account; and responsive to determining the transaction exceeds the predetermined threshold, authorize the transaction based on the one or more respective features of the one or more second accounts.

Clause 7: The system of clause 6, wherein the predetermined threshold comprises a transaction amount, a credit limit, or both.

Clause 8: The system of clause 1, wherein the instructions are further configured to cause the system to: receive a request to complete a transaction using the first account; and responsive to consolidating the one or more second accounts into the first account, authorize the transaction based on the one or more respective features of the first account.

Clause 9: A system comprising: one or more processors; and a memory in communication with the one or more processors and storing instructions that, when executed by the one or more processors, are configured to cause the system to: receive data corresponding to a user, the data comprising a plurality of accounts; determine, via a first machine learning model (MLM) and based on the data, a first account of the plurality of accounts to use as a primary account; cause a user device to display, via a graphical user interface (GUI), a first notification indicating the first account as the primary account, the user device associated with the user; normalize, via a second MLM, one or more respective features of one or more second accounts of the plurality of accounts in comparison to the one or more respective features of the first account; cause the user device to display, via the GUI, a second notification indicating a consolidation of the one or more second accounts into the first account based on the normalized one or more respective features; and consolidate the one or more second accounts into the first account.

Clause 10: The system of clause 9, wherein the data comprises one or more of financial information, transaction information, credit information, travel information, a date, a time, or combinations thereof.

Clause 11: The system of clause 9, wherein the second MLM comprises a neural network.

Clause 12: The system of clause 9, wherein the one or more respective features comprise one or more of interest rate, credit line, fees, rewards, points, cashback percentage, benefits, or combinations thereof.

Clause 13: The system of clause 9, wherein the instructions are further configured to cause the system to: receive a request to complete a transaction using the first account; responsive to consolidating the one or more second accounts into the first account, determine whether the transaction exceeds a predetermined threshold; responsive to determining the transaction does not exceed the predetermined threshold, authorize the transaction based on the one or more respective features of the first account; and responsive to determining the transaction exceeds the predetermined threshold, authorize the transaction based on the one or more respective features of the one or more second accounts.

Clause 14: The system of clause 13, wherein the predetermined threshold comprises a transaction amount, a credit limit, or both.

Clause 15: The system of clause 9, wherein the instructions are further configured to cause the system to: receive a request to complete a transaction using the first account; and responsive to consolidating the one or more second accounts into the first account, authorize the transaction based on the one or more respective features of the first account.

Clause 16: A system comprising: one or more processors; and a memory in communication with the one or more processors and storing instructions that, when executed by the one or more processors, are configured to cause the system to: receive data corresponding to a user, the data comprising a plurality of accounts; cause a user device to display, via a graphical user interface (GUI), a listing of the plurality of accounts and one or more selectable user input objects proximate each of the plurality of accounts, wherein the user device is associated with the user; receive, from the user via the user device, a first selection of the one or more selectable user input objects, the first selection indicating a first preference to assign a first account of the plurality of accounts as a primary account of the user; responsive to receiving the first selection: modify the GUI to generate a first modified GUI including an indication of the first account as the primary account; and cause the user device to display the first modified GUI; receive, from the user via the user device, a second selection of the one or more selectable user input objects, the second selection indicating a second preference to consolidate a second account of the plurality of accounts with the first account; responsive to receiving the second selection: consolidate the second account into the first account; and retrieve one or more respective features of the first and second accounts; receive a request to complete a transaction using the first account; determine whether the transaction exceeds a predetermined threshold; responsive to determining the transaction does not exceed the predetermined threshold, authorize the transaction based on the one or more respective features of the first account; and responsive to determining the transaction exceeds the predetermined threshold, authorize the transaction based on the one or more respective features of the second account.

Clause 17: The system of clause 16, wherein the data comprises one or more of financial information, transaction information, credit information, travel information, a date, a time, or combinations thereof.

Clause 18: The system of clause 16, wherein the one or more selectable user input objects comprise one or more of a toggle, a drop-down menu, a text box, a radio button, a slider button, or combinations thereof.

Clause 19: The system of clause 16, wherein the one or more respective features comprise one or more of interest rate, credit line, fees, rewards, points, cashback percentage, benefits, or combinations thereof.

Clause 20: The system of clause 16, wherein the predetermined threshold comprises a transaction amount, a credit limit, or both.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IOT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment.” “an embodiment,” “some embodiments,” “example embodiment,” “various embodiments,” “one implementation,” “an implementation,” “example implementation,” “various implementations.” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
one or more processors; and
a memory in communication with the one or more processors and storing instructions that, when executed by the one or more processors, are configured to cause the system to:
receive data corresponding to a user, the data comprising a plurality of accounts;
retrieve travel information based on the data;
generate, via a first machine learning model (MLM) and based on the data and the travel information, a first recommendation for a first account of the plurality of accounts to use as a primary account;
cause a user device to display, via a graphical user interface (GUI), a first notification including the first recommendation, the user device associated with the user;
receive, from the user via the user device, a first response to the first notification;
responsive to receiving the first response, normalize, via a second MLM, one or more respective features of one or more second accounts of the plurality of accounts in comparison to the one or more respective features of the first account;
cause the user device to display, via the GUI, a second notification including a second recommendation for consolidating the one or more second accounts into the first account based on the normalized one or more respective features;
receive, from the user via the user device, a second response to the second notification; and
responsive to receiving the second response, consolidate the one or more second accounts into the first account based on the second recommendation.

2. The system of claim 1, wherein the data comprises one or more of financial information, transaction information, credit information, a travel destination, a date, a time, or combinations thereof.

3. The system of claim 1, wherein the travel information comprises one or more of travel advisories, foreign transaction fees, or both.

4. The system of claim 1, wherein the second MLM comprises a neural network.

5. The system of claim 1, wherein the one or more respective features comprise one or more of interest rate, credit line, fees, rewards, points, cashback percentage, benefits, or combinations thereof.

6. The system of claim 1, wherein the instructions are further configured to cause the system to:
receive a request to complete a transaction using the first account;
responsive to consolidating the one or more second accounts into the first account, determine whether the transaction exceeds a predetermined threshold;
responsive to determining the transaction does not exceed the predetermined threshold, authorize the transaction based on the one or more respective features of the first account; and
responsive to determining the transaction exceeds the predetermined threshold, authorize the transaction based on the one or more respective features of the one or more second accounts.

7. The system of claim 6, wherein the predetermined threshold comprises a transaction amount, a credit limit, or both.

8. The system of claim 1, wherein the instructions are further configured to cause the system to:
receive a request to complete a transaction using the first account; and
responsive to consolidating the one or more second accounts into the first account, authorize the transaction based on the one or more respective features of the first account.

9. A system comprising:
one or more processors; and
a memory in communication with the one or more processors and storing instructions that, when executed by the one or more processors, are configured to cause the system to:
receive data corresponding to a user, the data comprising a plurality of accounts;
determine, via a first machine learning model (MLM) and based on the data, a first account of the plurality of accounts to use as a primary account;
cause a user device to display, via a graphical user interface (GUI), a first notification indicating the first account as the primary account, the user device associated with the user;
normalize, via a second MLM, one or more respective features of one or more second accounts of the plurality of accounts in comparison to the one or more respective features of the first account;
cause the user device to display, via the GUI, a second notification indicating a consolidation of the one or more second accounts into the first account based on the normalized one or more respective features; and
consolidate the one or more second accounts into the first account.

10. The system of claim 9, wherein the data comprises one or more of financial information, transaction information, credit information, travel information, a date, a time, or combinations thereof.

11. The system of claim 9, wherein the second MLM comprises a neural network.

12. The system of claim 9, wherein the one or more respective features comprise one or more of interest rate, credit line, fees, rewards, points, cashback percentage, benefits, or combinations thereof.

13. The system of claim 9, wherein the instructions are further configured to cause the system to:
receive a request to complete a transaction using the first account;
responsive to consolidating the one or more second accounts into the first account, determine whether the transaction exceeds a predetermined threshold;
responsive to determining the transaction does not exceed the predetermined threshold, authorize the transaction based on the one or more respective features of the first account; and
responsive to determining the transaction exceeds the predetermined threshold, authorize the transaction based on the one or more respective features of the one or more second accounts.

14. The system of claim 13, wherein the predetermined threshold comprises a transaction amount, a credit limit, or both.

15. The system of claim 9, wherein the instructions are further configured to cause the system to:
receive a request to complete a transaction using the first account; and
responsive to consolidating the one or more second accounts into the first account, authorize the transaction based on the one or more respective features of the first account.

16. A system comprising:
one or more processors; and
a memory in communication with the one or more processors and storing instructions that, when executed by the one or more processors, are configured to cause the system to:
receive data corresponding to a user, the data comprising a plurality of accounts;
cause a user device to display, via a graphical user interface (GUI), a listing of the plurality of accounts and one or more selectable user input objects proximate each of the plurality of accounts, wherein the user device is associated with the user;
receive, from the user via the user device, a first selection of the one or more selectable user input objects, the first selection indicating a first preference to assign a first account of the plurality of accounts as a primary account of the user;
responsive to receiving the first selection:
modify the GUI to generate a first modified GUI including an indication of the first account as the primary account; and
cause the user device to display the first modified GUI;
receive, from the user via the user device, a second selection of the one or more selectable user input objects, the second selection indicating a second preference to consolidate a second account of the plurality of accounts with the first account;
responsive to receiving the second selection:
consolidate the second account into the first account; and
retrieve one or more respective features of the first and second accounts;
receive a request to complete a transaction using the first account;
determine whether the transaction exceeds a predetermined threshold;
responsive to determining the transaction does not exceed the predetermined
threshold, authorize the transaction based on the one or more respective features of the first account; and
responsive to determining the transaction exceeds the predetermined threshold, authorize the transaction based on the one or more respective features of the second account.

17. The system of claim 16, wherein the data comprises one or more of financial information, transaction information, credit information, travel information, a date, a time, or combinations thereof.

18. The system of claim 16, wherein the one or more selectable user input objects comprise one or more of a toggle, a drop-down menu, a text box, a radio button, a slider button, or combinations thereof.

19. The system of claim 16, wherein the one or more respective features comprise one or more of interest rate, credit line, fees, rewards, points, cashback percentage, benefits, or combinations thereof.

20. The system of claim 16, wherein the predetermined threshold comprises a transaction amount, a credit limit, or both.
